(19) United States
(12) Patent Application Publication
(10) Pub. No.: US 2004/0107155 A1
(43) Pub. Date: Jun. 3, 2004

(54) Open adaptive service trading system and method thereof

(75) Inventor: John Anthony Yanosy, Grapevine, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/307,136

(22) Filed: Nov. 29, 2002

(51) Int. Cl. G06F 17/60

(52) U.S. Cl. 705/37

(57) ABSTRACT

An open service trading system (10) and method therein enables the reselling of services among brokers (18), resellers (16) and service providers (14) to service subscribers (12). The service trading system (10) comprises domain specific knowledge bases (22a-40a) constrained by respective ontology domains (22b-40b), where the ontology domains (22b-40b) together define a service trading ontology structure. In addition, rational agents (42-70) are each committed to one or more of the domain specific knowledge bases (22a-40a) to enable interaction with others of the rational agents to achieve associated participant trading goals as defined within the service trading ontology structure.

### BACKGROUND OF THE INVENTION

1. Field of the Invention

The present invention relates to wireless communications, and specifically to a service trading system and methodology that enables participants to buy, sell and/or trade wireless services in a dynamic open environment.

2. Description of Related Art

Presently, wireless service providers (service providers) are limited in the manner in which they can sell their wireless services. For example, such service providers currently have static tiered service plans that are not suitable for the host of potential new wireless services that could be enabled by Internet protocol (IP) wireless networks, application services and wide area protocol (WAP) equivalent access. Therefore, they have no flexibility to dynamically tailor their economic valuation or pricing and transaction methods for offering services in reaction or anticipation to service demand, or to tailor service bundles based on customer demand. As a result, such service providers have no way of establishing an open service trading environment to reinforce or encourage the economic viability of new service offerings.

In addition, wireless service providers have no systems by which to easily and dynamically offer their services to customers through partners such as brokers and resellers in an on-line environment, or to facilitate interaction between the customers and the service providers themselves, and/or between the customers and the brokers and resellers, through respective online agents to browse and find services and products with semantic correctness, and to dynamically negotiate and conduct on-line economic transactions.

The above-mentioned limitations are due in large part to technical limitations. Specifically, there is no described ontology based on standard ontology languages that could be construed as forming a foundation for the above-discussed open service trading environment. Similarly, there is no architecture defined for enabling an open service trading environment that could be used in different market segments and that could be tailored for different economic trading schemes. This is due in large part to the fact that separation of the knowledge associated with service trading from the code is a real problem and constrains current service provider systems to their original respective domains.

Most service provider systems only offer capabilities for browsing products, selecting products to be added to shopping carts, and then supporting economic transaction for those items in the shopping cart. Therefore, there is no ability for a customer software agent realized, for example, by a software component, to interact with an on-line service provider using a standard published language associated with the product domain and product acquisition domain. This is because software agents in product or service acquisition applications typically have their relationships to databases and the fields of the database tightly coupled with their code. As a result, these agents are not sufficiently adaptable enough to be modified through the use of dynamically established policies that influence the trading schemes, such as valuation and transaction types, or trading types used. In addition, the databases related to the software agents may have common fields and therefore may have the highest potential for reuse, but still are not necessarily defined in a broad enough manner and are not defined in a manner that allows different logical inferences to be made in a semantically correct manner for a specific domain.

Therefore, what is needed is a service trading system and methodology that enables participants to buy, sell and/or trade wireless services in a dynamic open environment, preferably, through software defined agents whose actions are defined by ontology constrained knowledge bases.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1, FIG. 2, and FIG. 3 together show a logical block diagram of a service trading system including participant agents, a service trading ontology structure, and knowledge bases;

FIG. 4 shows a layout arrangement of FIG. 5 through FIG. 9; and

FIG. 5, FIG. 6, FIG. 7, FIG. 8, and FIG. 9 together show a logical block diagram depicting the service trading ontology domains of FIG. 1 through FIG. 3 in more detail.

### DETAILED DESCRIPTION OF THE PRESENTLY PREFERRED EXEMPLARY EMBODIMENTS

In overview, the present disclosure concerns systems, methods, and equipment or apparatus that provide communications services to users of such systems and equipment and specifically techniques for facilitating reasonable access to such services via a dynamic and open services negotiation and trading environment. More particularly various inventive concepts and principles embodied as devices, systems, and methods therein for facilitating negotiations for services between suppliers and users of such services in a reasonable fashion taking into consideration various relevant factors explicitly or implicitly contained in corresponding databases all for the convenience and advantage of suppliers or users of such services are discussed and described. Networks of particular interest may be organized on a wide area network (WAN) or local area network (LAN) basis generally in a structured manner and are likely to be suitable for modest or more bandwidth communications. In particular the systems and methods may be especially beneficial for more recent systems with significantly expanded bandwidth, thus possible services, such as GPRS (General Packet Radio Systems), WCDMA (Wideband Code Division Multiple), UMTS (Universal Mobile Telecommunications Services) systems and the like or evolutions thereof.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs and instructions. It is expected that one of ordinary skill, notwithstanding possibly significant effort and many design choices motivated by, for example, available time, current technology, and economic considerations, when guided by the concepts and principles disclosed herein will be readily capable of generating such software instructions with minimal experimentation. Therefore, in the interest of brevity and minimization of any risk of obscuring the principles and concepts according to the present invention, further discussion of such software, if any, will be limited to the essentials with respect to the principles and concepts used by the preferred embodiments.

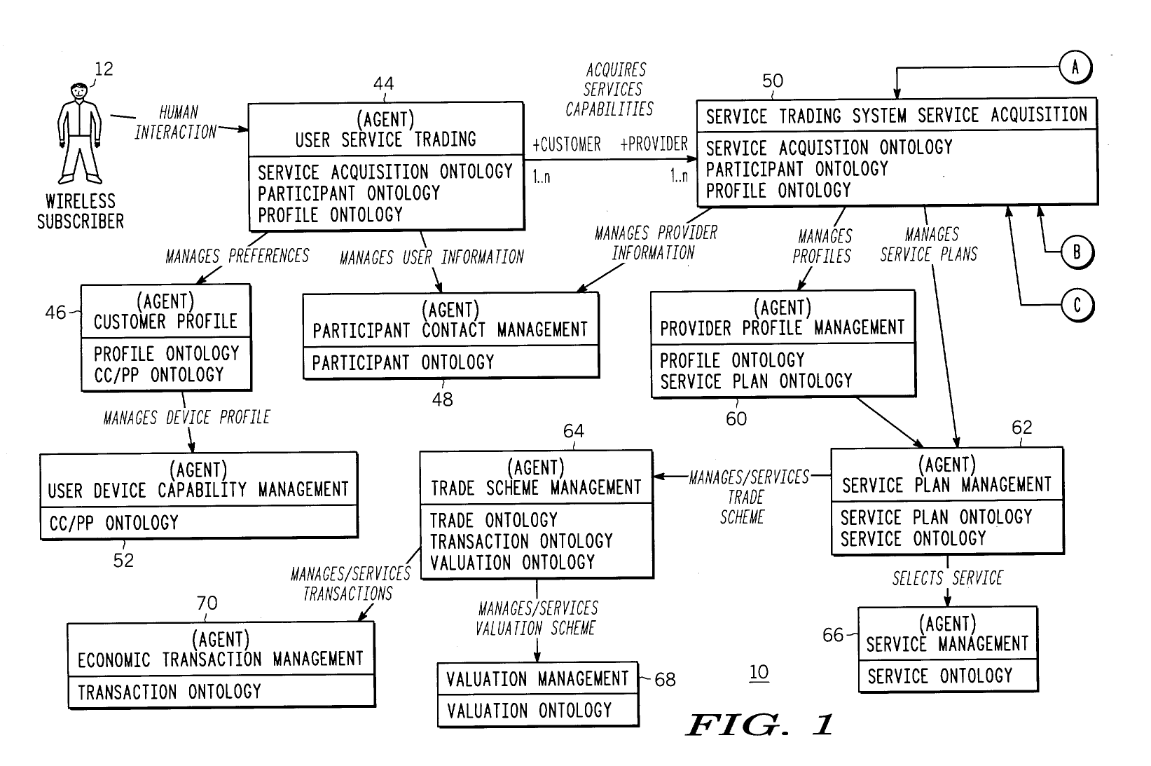

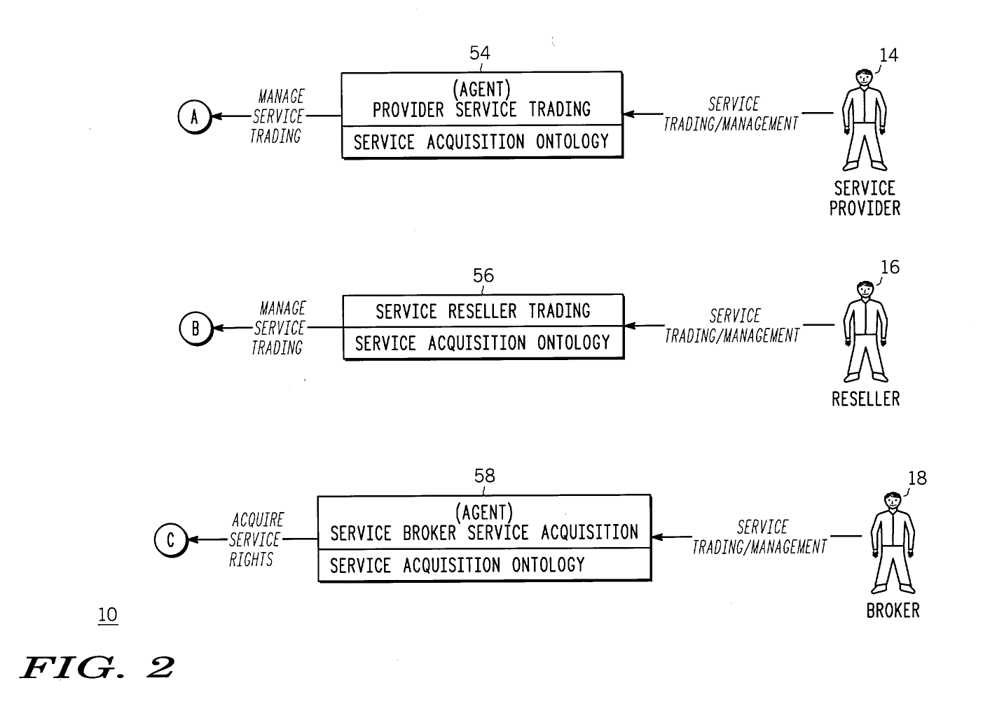

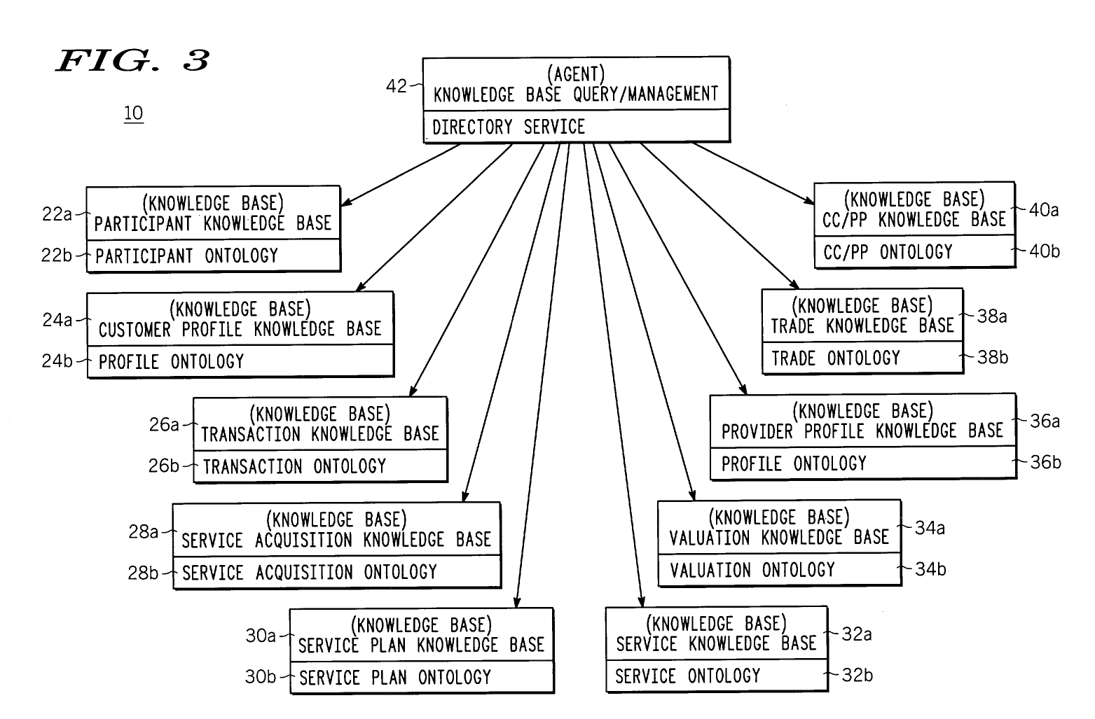

Referring now to the drawings in which like numerals reference like parts, FIG. 1 through FIG. 3 shows a service trading system 10. The service trading system 10 enables participants, such as wireless subscribers, represented by the subscriber 12, to browse, select and purchase wireless services from other participants (see FIG. 2, such as service providers, represented by the service provider 14, resellers, represented by the reseller 16 and brokers, represented by the broker 18, in a rational manner.

The service trading system 10 includes domain specific knowledge bases, such as the knowledge bases 22a-40a constrained by respective ontology domains, such as the ontology domains (knowledge base ontology domains) 22b-40b, wherein the ontology domains together define a service trading ontology structure (see FIG. 3). In addition, the service trading system 10 also includes rational agents, such as the rational agents (agents) 42-70, each of which is committed to one or more of the knowledge bases 22a-40a to enable it to interact with other rational agents to achieve associated trading goals of participants, such as the above mentioned wireless subscribers, service providers, resellers and brokers, as defined within the service trading ontology structure, as well as overall system goals, and to separate the knowledge associated with the service trading ontology structure from the underlying software code.

Although the service trading system 10 will be described for purposes of discussion in terms of a wireless services trading system, it should be appreciated that services and/or products of any type may be offered, browsed, selected, traded, negotiated for, bought, sold and re-sold using such a system, such as an e-commerce trading system based on websites providing services and products.

The wireless subscriber 12 may desire, for example, one or more of the following: to acquire the right to utilize services from a service provider such as the service provider 14; to obtain the best price for services, to be alerted to and possibly subscribe to new services as they become available; to have automatic computer support to optimize his or her cost for services as service needs change; and/or to have available services automatically and dynamically tailored as his or her needs change and according to profiles and policies that he or she controls. The wireless subscriber 12 may also be interested in deriving value from purchased services that will most likely not be utilized in a billing period, and as such is interested in being a more active participant in a new service trading environment for the purposes of lowering costs when service needs are lower, as well as when service needs are higher and more varied.

The service provider 14 may be not only a wireless service provider, but also any other on-line service provider that is interested in, for example, achieving the highest revenue stream possible from its investment in technology and the offering of on-line services to its customers. The service provider 14 may also be an entity that is interested in having a computer system enable a more dynamic service trading environment that can more closely adapt to its business strategy, its customer desires, and the competitive environment. To the extent possible, the service provider 14 may also be interested in exploring different kinds of distribution means through business partnerships and other relationships so that other entities, such as the reseller 16 or the broker 18, can resell or broker its service sales to customers such as the subscriber 12. In addition, the service provider 14 may be interested in agents to monitor its dynamic service demand environment and interact with the agents of other participants to determine opportunities for new service negotiations that would increase revenues and/or profits from services. The theory is that agents would be able to respond dynamically to changing service needs from customers and other partners and, through interactions, construct a better economic situation for the service provider 14 and customers such as the subscriber 12.

The reseller 16 may represent any business entity that, for example, purchases service rights from the service provider 14 and that resells these rights to service customers such as the subscriber 12. The theory behind this business model is that of volume discounting, which enables the reseller 16 (and service provider 14 for that matter) to pass on some savings to the subscriber 12 while still retaining a profit. The service provider 14 may encourage this business model to attract another market segment and to lower its operations costs. Therefore, there typically must be close computer interaction between the systems of the service provider 14 and the reseller 16 to ensure coordination.

In addition to the reseller 16, any third party such as a corporate entity or other organizational entity (not shown) may negotiate volume discounting for similar purposes to lower its costs and more closely match the service needs of associates in its organization. Ideally, such an entity would also have computer systems that interacted closely with the system of the service provider 14 to dynamically monitor and autonomously negotiate its service agreements for more optimal matching of needs and goals. Obviously, such a new service agreement may require final human authorization, but most of the analysis of needs and economic situation dynamics would be accomplished by software agents representing the respective participants such as those described below.

The service broker 18 is an entity that does not own any rights to services offered by the service provider 14, but that instead offers another entry for service acquisition for customers such as the subscriber 12 in a different context. For example, websites such as, for example, www.amazon.com, might be capable of offering customers the ability to acquire wireless services from one or more service providers. The broker 18 would therefore necessarily require that its computer system interact with that of the service provider 14. Collectively or individually the subscriber(s), service provider(s), service reseller(s), service broker(s), etc can be referred to as participants in the services trading system 10.

The knowledge bases 22a-40a are actual database instantiations constrained by the respective ontology domains 22b-40b and are implemented on a single server, or on multiple servers in a distributed relational database environment, in a network used to implement the service trading system 10. Realization of the knowledge bases 22a-40a can be accomplished by mapping table structures and relations to any commercial relational database management system, but will be accessible via logical queries within the defined semantic capabilities of the respective ontology domains 22b-40b and their associated constraints.

The ontology domains 22b-40b are preferably created using Semantic Web Ontology creation languages, such as Resource Description Framework (RDF), Resource Description Framework Schema (RDFS), Resource Description Framework/Extensible Markup Language (RDF/XML) and DARPA Agent Markup Language+Ontology Inference Layer (DAML+OIL) or the newest W3C Ontology Web Language (OWL). Use of these languages will enable the creation of defined ontologies with links to already defined ontologies that may be referenced to the World Wide Web (WWW) and thus constructed by other experts or organizations in specific domains. For example, the Trade Ontology Domain 38b in FIG. 2 may reference or import other ontologies on the WWW.

More specifically, each of the ontology domains 22b-40b is a catalog of the types of things that are assumed to exist in a domain of interest from the perspective of a person who uses a language for the purpose of talking about the domain of interest. The types in each ontology domain represent the vocabulary of the language when used to discuss topics in the domain of interest. The combination of logic with such an ontology domain provides a language that can express relationships about the entities in the domain of interest and enable other logical inferences that are not explicitly expressed in the knowledge bases 22a-40a.

Put another way, each of the ontology domains 22b-40b contains a definition of a vocabulary or language of discourse that can be used to reason within a specific domain of interest. In addition, each also contains not only definitions of the terms of the vocabulary within a specific domain of interest, but also syntax rules for making well formed expressions and semantic definitions that enable reasoning about the knowledge contained in the respective knowledge bases 22a-40a conformant therewith or, in other words, constrained thereby. In addition, the ontology domains 22b-40b may include a predefined set of specific ontologies associated with individual participant goals and constraints and used to construct participant specific knowledge bases that guide service trading system actions.

The reasoning or inferential capability allows many different sorts of queries to be made against the respective knowledge domains 22b-40b for the purposes of determining appropriate actions to be taken by the associated agents 42-70. In this respect, the overall service trading ontology structure defined by the ontology domains 22b-40b defines and constrains the language of communication among the agents 42-70 and the knowledge they can use to reason about action plans to achieve agent and system goals without describing any actual agent functional behavior. As a result, the service trading ontology should preferably be developed iteratively as behavior and knowledge requirements of the service trading system 10 are developed.

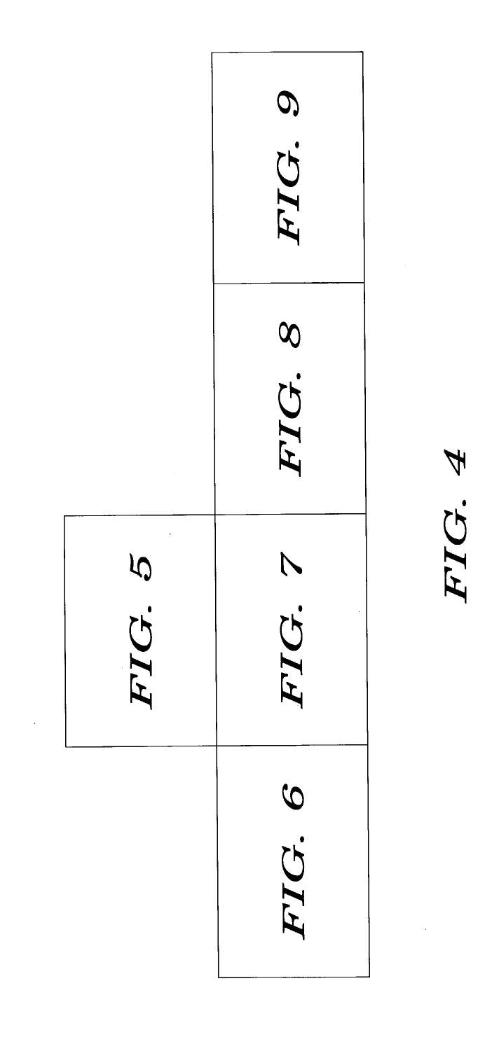

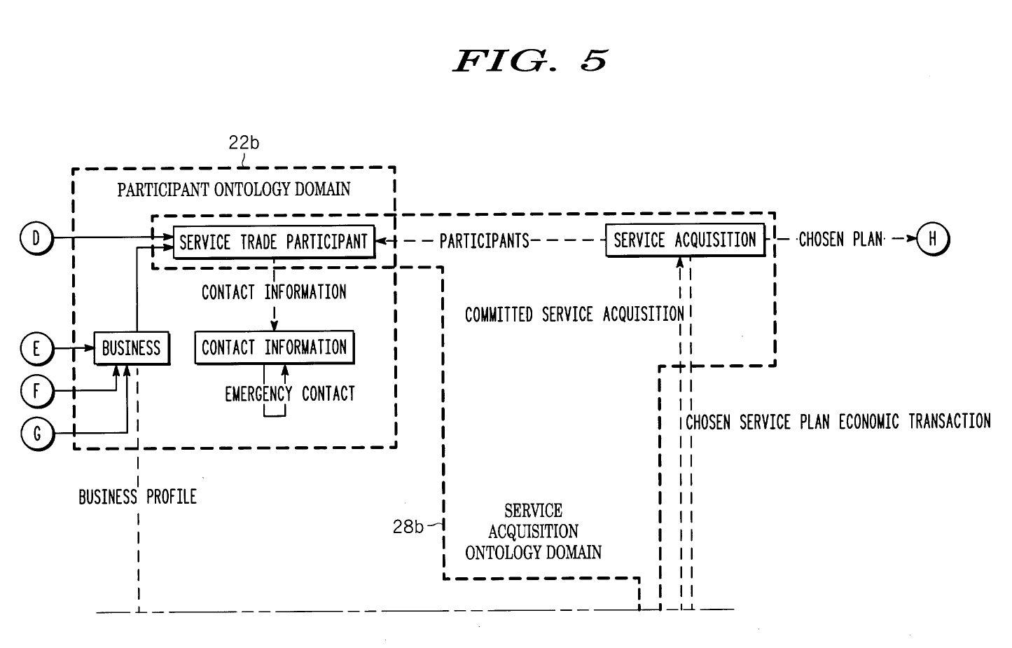

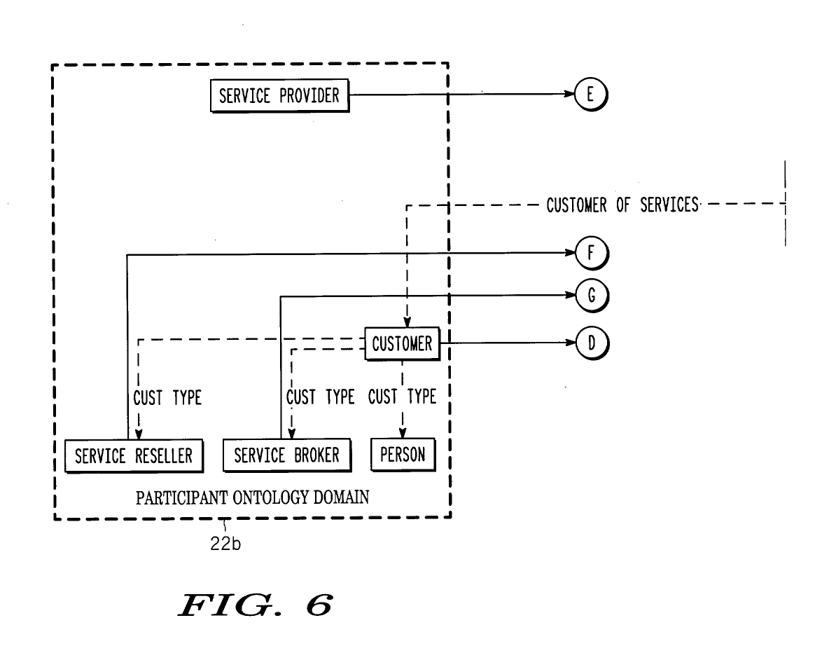

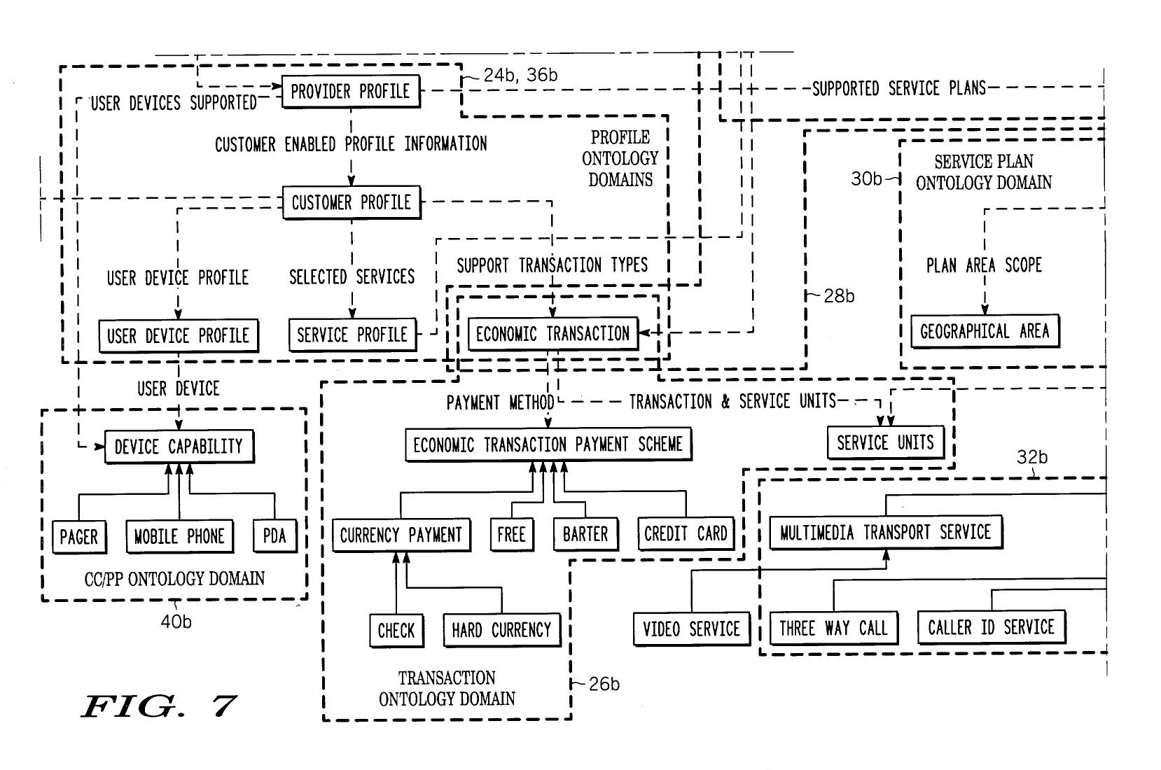

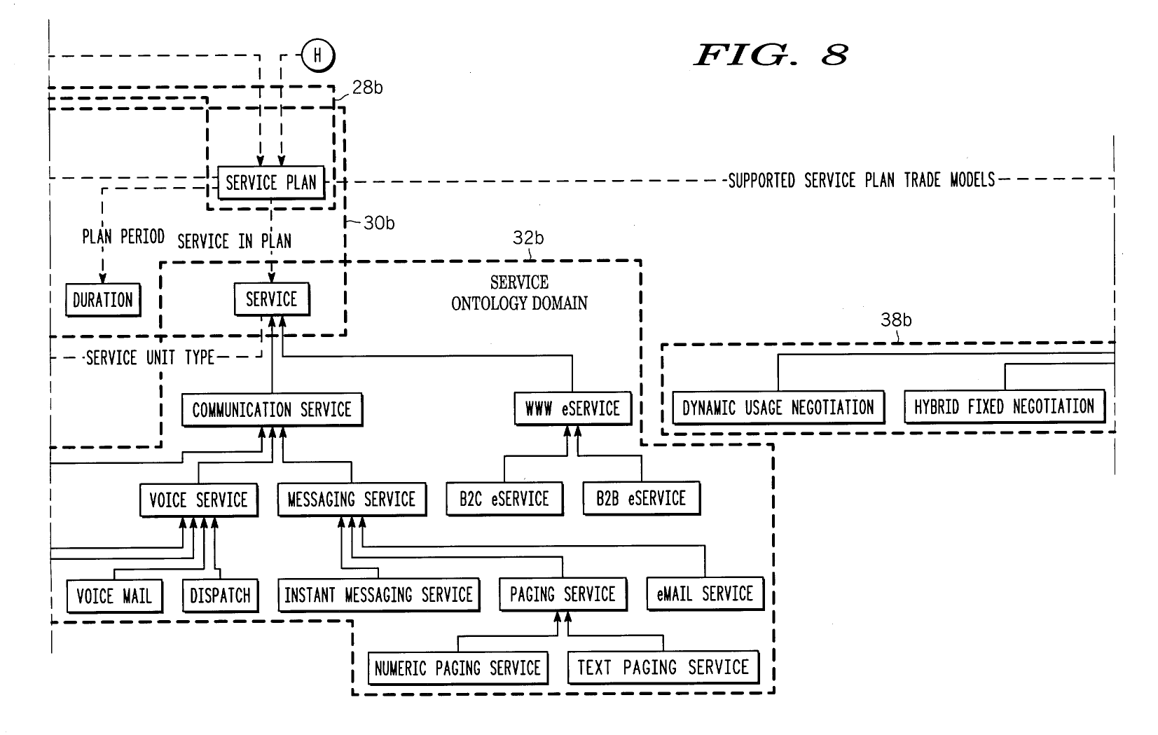

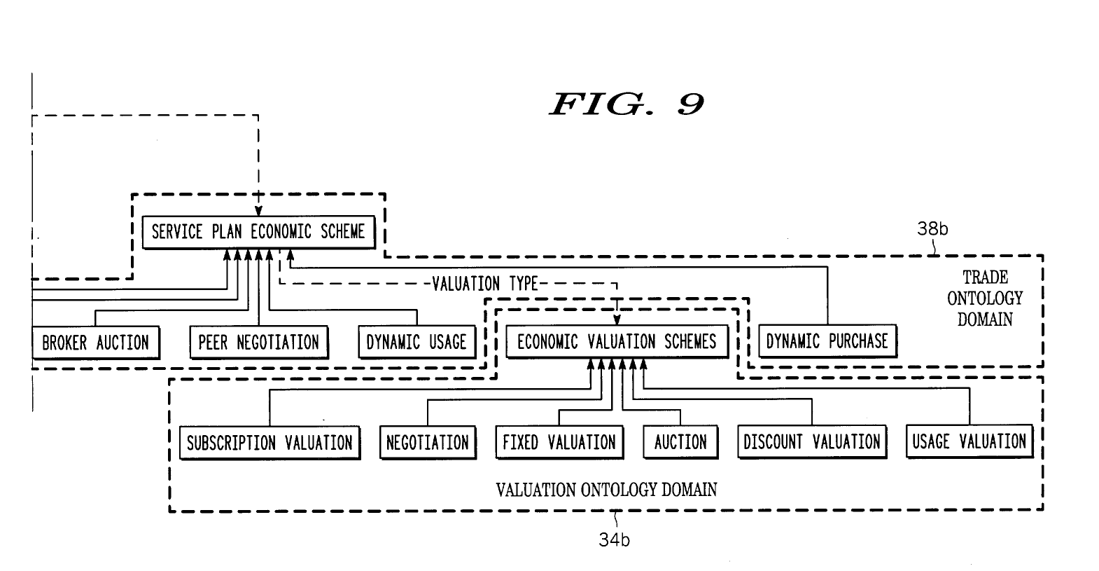

Referring now to FIGS. 1-3, FIG. 4, and FIGS. 5-9, the ontology domains 22b-40b forming the service trading ontology represent those domains necessary to provide a vocabulary or language of discourse for use by the rational agents 42-70 to coordinate their actions, to deliberate about their intentions, and to reason about the most appropriate action plans to achieve their intentions and to thereby implement the service trading system 10. The boxes within the ontology domains 22b-40b represent classes within respective ontology domains 22b-40b, with the classes containing respective class identifying names and as well as class attributes, or in other words subclass related information. A class that is related to another class in a manner so that it inherits all properties of the other class is referred to also as a subclass with respect to the other class. In FIGS. 5-9, dotted arrow lines between two classes represent a logical relationship link, while solid lines between two classes represent a class/subclass relationship.

Specifically, the Participant Ontology Domain 22b (see FIGS. 3, 5, 6) provides definitions to create knowledge about service trading system participants and the form of their participation. For example, the Service Trade Participant Class identifies, or in other words is linked through a Contact Information logical relationship to, a Contact Information Class. In turn, a Customer Class and a Business Class are linked to the Service Trade Participant Class through an ISA class/subclass relationship link, and therefore are subclasses of the Service Trade Participant Class and inherit all of its properties. The Customer Class is also linked through respective Customer Type logical relationships to Service Reseller, Service Broker and Person Classes.

In addition, the Customer Class also is linked through a Customer or Services logical relationship to a Customer Profile Class in the Profile Ontology Domains 24b, 36b (shown together for ease of illustration), wherein the Profile Ontology Domains 24b, 36b define the relationships between participants and their policies associated with supported user devices, service profiles, and economic transaction schemes. The relationship between the Customer Class and the Customer Profile Class illustrates how two classes in two respective ontology domains may be logically related, and therefore how the ontology domains 22b-40b may all be interrelated. The diagram in FIGS. 5-9 defines the structure of relationships between the classes within each ontology domain, and the relationships between ontologies, and thus provides a comprehensive knowledge system specification for supporting reasoning. Other ontology domains shown in FIGS. 5-9 will therefore only be briefly discussed without detailed discussion regarding class relationships therein.

The Transaction Ontology Domain 26b provides the definitions for actual transaction types supported by the Service Acquisition Ontology Domain 28b and desired by customers. Exemplary transaction classes include Currency Payment, Free, Barter and Credit Card Classes. The Service Acquisition Ontology Domain 28b in turn is linked through logical relationships to classes in two other constituent top-level ontology domains necessary for supporting service acquisition in addition to the Transaction Ontology Domain 26b, namely, the Participant and Service Plan Domains 22b, 30b, and the Service Profile of the Profile Ontology Domains 24b, 36b.

The Service Plan Ontology Domain 30b defines the bundles of services associated with each service plan offered by the service provider 14, their geographical scope, their plan duration options, and the relationship to detailed service models in the Service Ontology Domain 32b. In addition, the Service Plan Class within the Service Plan Ontology Domain 30b defines logical relationships with the Provider Profile of the Profile Ontology Domains 24b, 36b, and Service Plan Economic Scheme Classes in the Trade Ontology Domain 38b.

The Service Ontology Domain 32b defines the types of services and their attributes and is linked through a logical relationship to a Service Units Class in the Transaction Ontology Domain 26b. The exemplary service classes, shown specifically in FIG. 8, include a Communication Service Class and WWW eService Class, with each type of service having associated constituent service classes. The Communication Service Class includes subclasses, such as Multimedia Transport Service, Voice Service, and Messaging Service, while the WWW eService Class includes subclasses such as B2C eService (Business to Consumer electronic Service) and B2B eService (Business to Business electronic Service). Other types of Service subclasses can be added at future dates to extend the capabilities of the service trading system 10.

The Trade Ontology Domain 38b provides ontology definitions for determining the type of economic trade scheme and the supported valuation scheme. It includes a Service Plan Economic Scheme Class that is linked through a logical relationship to an Economic Valuation Schemes class in the Valuation Ontology Domain 34b. Examples of types of possible economic trades schemes and associated valuation schemes include: dynamic purchase (non-negotiable fixed price but dynamic with respect to billing service period); broker auction (auction at volume discount pricing); brokered dynamic purchase (volume discount pricing at non-negotiable fixed price); peer negotiation (negotiation for services and pricing); hybrid fixed/peer negotiation (negotiation after fixed services exceeded); dynamic usage (pure usage at fixed non-negotiable price); and dynamic usage negotiation (pure usage at negotiated price). The Valuation Ontology Domain 34b defines the valuation of service capabilities as discussed above in connection with the Trade Ontology Domain 38b.

The Composite Capabilities/Personal Preferences (CC/PP) Ontology Domain 40b is based on the W3C CC/PP ontology for device composite capabilities and user preferences. The CC/PP Ontology Domain 40b includes a Device Capability Class and constituent subclasses to which Provider Profile and User Device Profile Classes in the Profile Ontology Domains 24b, 36b are linked through logical relationships.

Referring back to FIGS. 1-3, the agents 42-70 are software entities such as software components realized through commercially available middleware, or through language for distributed software environments such as Java servelets, CORBA, Java2 Enterprise Environment (J2EE) or Web Architectures. The agents 42-70 are intelligent and may be dynamically created as trading participants enable or disable trading activities on their own behalf, and where the agents 42-70 act as proxies on behalf of the participants to achieve the objectives of the participants through inter-agent interaction as well as with services provided by mediating agents within the service trading system 10.

The agents 42-70 reside, for example, on user devices as well as a single server, or on multiple servers in a distributed software environment, to implement the desired behavior of the service trading system 10 or specifically participants therein and to provide the end reasoning necessary to leverage the knowledge bases 22a-40a associated with the different ontology domains 22b-40b. The agents 42-70 are provided within an agent architecture based on any available agent platform, such as JAVA Agent Development Environment (JADE™) or Lightweight Extensible Agent Platform (LEAP), that is compliant with the Foundation For Intelligent Physical Agents (FIPA) abstract architecture and its well known related supporting services such as the Directory Facilitator.

Each of the agents 42-70 assumes a specified role by being committed to one or more of the knowledge bases 22a-40a through the Knowledge Base Query Management Agent 42 and interacts with other agents to elicit commitments and coordination of actions. Generally, a rational agent, such as those discussed herein, in operation receives a request or negotiation request from a participant or corresponding participant and operates, on behalf of the participant to perform matching between candidate participant trades or possible trades that would achieve the individual participant objectives reflected by the request within the constraints imposed thereon by the underlying ontology domains(s).

Communications between agents is based on FIPA Agent Communication Languages (ACLs) during various defined phases within a negotiating cycle, where message performatives are of the speech act type, and message contents are statements consistent within the ontology domain(s) to which it is committed. Each of the agents 42-70 accomplishes means/end logical reasoning that integrates its knowledge for the purpose of deliberating about the appropriate action plans that could be used to achieve its goals. In addition, each of the agents 42-70 determines a current execution plan that it intends to follow based on this means/end logical reasoning and based on further information (additional constraints) entered by participants through the participant knowledge base 22a and therefore the Participant Ontology Domain 22b.

The service trading system 10 ensures equal treatment of all trading activities and participant goals by synchronizing system wide activities into different phases and by ensuring all participants and all of the agents 42-70 have the opportunity to have their actions completed or initiated during an appropriate phase in a negotiating cycle, with activity phases being defined as, for example, participant addition/deletion, participant trade specifications, participant goal/policy specification, trade offerings or bids, valuation analysis of trade offers, trade agreement/commitment, trade execution and completion, trade status update and cycle repeat. New participants typically are permitted to enter only at the beginning of a new cycle.

Referring now to the features of the individual agents, the User Service Trading Agent 44 is committed to the Service Acquisition Ontology Domain 28b, the Participant Ontology Domain 22b and the Profile Ontology Domain 24b through the Knowledge Base Query Management agent 42 constrained by the Directory Service Ontology Domain (which, for discussion purposes, will be considered to be a part of the Service Ontology Domain 32b) to enable the User Service Trading Agent 44 to acquire service capabilities from the Customer Profile Agent 46, to manage user/subscriber information in conjunction with the Participant Contact Management Agent 48, and to manage subscriber preferences in conjunction with the Customer Profile Agent 42. In turn, the Customer Profile Agent 46 is committed to the Profile Ontology Domains 24b, 36b and the Composite Capabilities/Personal Preferences (CC/PP) Ontology Domain 40b to enable it to manage the device profile of customers such as the subscriber 12 and the service provider 14 through the User Device Capability Management Agent 52.

Also, the Service Trading System Service Acquisition Agent 50 is committed to the Service Acquisition Ontology Domain 28b to enable the User Service Trading Agent 44 to acquire service capabilities and to also enable the Service Broker Service Acquisition Agent 58 to acquire the rights to services of the service provider 14. The Service Trading System Service Acquisition Agent 50 is also committed to the Participant Ontology Domain 22b and the Profile Ontology Domain 24b to enable the Provider Service Trading Agent 54 to manage trading of services with the reseller 16, the broker 18 and/or the subscriber 12, and the Service Reseller Trading Agent 56 to manage the trading of services with the subscriber 12, the service provider 14 and/or the broker 18. Other agents are committed to one or more of the ontology domains 22b-40b in a similar manner to enable the agents 42-70 to communicate with one another in a dedicated manner to accomplish a specified function or functions.

It should now be appreciated in view of the foregoing that the service trading system 10 has many associated benefits. It provides an open trading system environment that enables participants to be dynamically added and that supports autonomous coordination and negotiation on behalf of participants in order to conduct service trading agreements and commitments. Common languages are used so that other software applications can interact with the service trading system 10 and other participants based on the service trading ontology defined by the ontology domains 22b-40b.

Examples of other types of applications that might interact with the service trading system 10 include a supply chain management system that coordinates purchases for an enterprise from its suppliers, or a business to business electronic directory that contains the services and product definitions that businesses could offer to each other. In the former example, the service trading system 10 could enhance the supply chain management system by providing an open environment where its suppliers could bid on purchase requests and potentially negotiate sub relationships among them to fulfill the original request. In the latter example, the service trading system 10 could access the business to business directory to supplement its definitions of products and services offered by each business and then use this information as part of its matching process for trading.

In addition, the service trading system 10 includes a multi agent architecture in which agent roles and interaction are constrained by FIPA speech acts and the message contents contained therein consistent with the ontology domains within associated knowledge bases. The service trading system 10 also enables the resultant behavior of agents to be changed in terms of their action plans without recoding agent programming, as well as enables the agents to infer new knowledge from knowledge bases in order to facilitate deliberation by agents regarding which action plans would best achieve objectives given the environmental state and overall objectives.

An example of this change in agent behavior is where the Service Plan Ontology Domain 30b of FIGS. 7-8 is modified to change the allowed duration of a service plan. This would have an effect on the Provider Profile Management Agent 60 and the Service Plan Management Agent 62 that are in communication with the Service Trading System Service Acquisition Agent 50. Specifically, a service plan may be about to expire for the subscriber 12 and thus new requests by the service provider 14 to trade existing service units may be denied.

The key aspect of agent design is that each ontology domain specifies a specific action for an agent who is committed to the ontology domain, and that certain states of knowledge in a knowledge base for this ontology domain will trigger the agent to perform this predefined action. The actions are encoded in the agent software, but the triggers for agent execution are contained in its associated ontology domains and knowledge bases. The knowledge bases can be created with different physical realizations as long as knowledge base interactions are based on standard interfaces such as KIF and as long as the results of queries are in conformance to the Semantic Web Ontology languages. Other ontology languages can be used, but this would limit the ability to reuse any referenced WWW available ontologies in the service trading system 10.

In addition, the service trading system 10 enables participant service providers to dynamically select and change the economic valuation and transactions schemes for each service they offer, and provides other participants with the ability to announce their support or desire for these schemes. The service trading system 10 also enables service providers, resellers and brokers to tailor economic trading parameters to changing economic environments and business strategies.

The service trading system 10 may also be configured as a secure system to maintain the privacy and security of trading information according to individual participant preferences and to system wide standards to ensure global security and privacy constraints. Preferably, individual participant preferences would be given priority over global settings. At all times global trading statistical information would be made available to all traders, but only consistent with the privacy and security concerns of each participant.

It is contemplated that the Profile Ontology Domains 24b, 36b (FIGS. 3 and 7) would be the ontologies related to the above security preferences. More specifically, the Customer and Provider Profiles within the Profile Ontology Domains 24b, 36b (FIG. 7) would contain security preferences related to the information that individual participants would allow to be shared or observed by other participants.

Security-related information that might be controlled by participants may include, for example: participant contact information; specific trade result information such as value of trade, item of trade, participants in trade, and/or date of trade; and available non-completed trade offers, except those made to certain classes of participants or specific participants. There are many instances of constraints that participants might like to state, but these in general will be specified as alternatives in the Profile Ontology Domains 24b, 36b

The architecture of the service trading system 10 is designed in a manner that enables subsets thereof to be customized and used for different market applications such as, for example, where there are no resellers or brokers.

Additionally, the service trading system could alternately be based on current Web architecture and software components operating on current distributed object oriented middleware, such as J2EE, or CORBA, and associated databases with tables and fields associated with system data elements. This approach, though currently possible, will be less flexible in reuse or applicability for different market segments or application interaction. In addition, the code would be tightly coupled in meaning of terms with no external semantic definition of the terms that others could understand. A person would have to evaluate the code, its variables, and its interpretation of the database information to determine the intended semantic meaning of the data element.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A service trading system comprising:
ontology domains together defining a service trading ontology structure;
domain specific knowledge bases respectively constrained by one or more of the ontology domains; and
rational agents, each being committed to one or more of the domain specific knowledge bases to thereby enable interaction with others of the rational agents to achieve associated participant trading goals as defined within the service trading ontology structure.

2. The service trading system of claim 1, wherein the ontology domains together define a wireless services trading ontology structure.

3. The service trading system of claim 1, wherein each of the ontology domains comprises a definition of a vocabulary used to reason within a specific domain of interest and syntax rules for making well formed expressions and semantic definitions for constraining those of the domain specific knowledge bases constructed thereby.

4. The service trading system of claim 1, wherein at least one of the rational agents, the domain specific knowledge bases, and the ontology domains is reusable outside of the service trading ontology structure.

5. The service trading system of claim 1, wherein the ontology domains comprise a predefined set of specific ontologies associated with individual participant goals and constraints and used to construct participant specific knowledge bases that guide service trading system actions.

6. The service trading system of claim 5, wherein the rational agents enable one of dynamic selection and changing of economic valuation and transaction schemes for offered services and tailoring of economic trading parameters to changing economic environments and business strategies through modification of the predefined set of specific ontologies associated with individual participant goals and constraints.

7. The service trading system of claim 1, wherein the ontology domains contain classes each of which forms one of a logical relationship link and a class/subclass relationship with one of classes co-located in a same ontology domain and classes located in others of the ontology domains.

8. The service trading system of claim 1, wherein the rational agents are programmed to infer new knowledge from the domain specific knowledge bases, thereby facilitating deliberation by the rational agents as to which action plans would best achieve individual participant objectives given overall participant objectives.

9. The service trading system of claim 1, wherein the rational agents are further constrained by data as input by participants into a participant domain specific knowledge base.

10. The service trading system of claim 9, wherein the rational agents are further constrained by data as input by participants into a participant domain specific knowledge base through a user service trading rational agent.

11. The service trading system of claim 1, wherein the rational agents interact with one another using a Foundation For Intelligent Physical Agents (FIPA) defined agent communication language, where message performatives are speech act type performatives, and message contents are statements within a committed one of the ontology domains.

12. The service trading system of claim 1, wherein one or more of the rational agents may be dynamically created as trading participants enable or disable trading activities on their own behalf.

13. A method of dynamically negotiating in an open service trading system, comprising:
receiving, at a rational agent, a participant negotiation request;
deliberating about and determining a current action plan based on means/end logical reasoning in view of system and participant constraints imposed through knowledge base ontology domains;
matching candidate participant trades that could achieve individual participant objectives;
interacting with other rational agents based on the current action plan; and
deciding upon negotiated parameters as a result of the interacting with other rational agents based on the current action plan.

14. The method of claim 13, wherein the receiving a participant negotiation request comprises receiving a participant negotiation request for wireless services.

15. The method of claim 14, wherein the receiving a participant negotiation request for wireless services comprises receiving one of a user negotiation request, a subscriber negotiation request, a service provider negotiation request, a reseller negotiation request, and a broker negotiation request.

16. The method of claim 13, wherein the interacting with other rational agents based on the current action plan comprises interacting with other rational agents to one of elicit action commitments and influence behavior of the other rational agents through sharing of domain knowledge, using Foundation For Intelligent Physical Agents (FIPA) Agent Communication Languages (ACLS) with speech type message performatives and message contents that are statements within a knowledge base ontology domain to which the rational agent is committed.

17. The method of claim 13, wherein the deliberating about and determining a current action plan based on means/end logical reasoning in view of system and participant constraints imposed through knowledge base ontology domains further comprises inferring new knowledge from the knowledge base ontology domains to facilitate deliberation regarding an action plan that would achieve participant objectives given a current economic environment and overall participant objectives.

18. The method of claim 13, wherein
the receiving of a participant negotiation request comprises receiving a wireless subscriber negotiation request; and
the interacting with other rational agents based on the current action plan comprises interacting with rational agents representing at least one of a service provider, a reseller and a broker.

19. The method of claim 13, further comprising, at the other rational agents, tailoring economic trading parameters responsive to economic environments and business strategies.

20. The method of claim 13, further comprising, at the rational agent, having system wide activities being synchronized into different phases to enable the rational agent to have its actions completed or initiated during an appropriate phase in a negotiating cycle.
